(19) United States
(12) Patent Application Publication
(10) Pub. No.: US 2018/0100395 A1
(43) Pub. Date: Apr. 12, 2018

(54) Vane Powered Rotor System

(71) Applicant: Stewart Systems Baking, LLC, Plano, TX (US)

(72) Inventor: Augusto Florindez, Plano, TX (US)

(21) Appl. No.: 15/728,667

(22) Filed: Oct. 10, 2017

Related U.S. Application Data
(60) Provisional application No. 62/406,281, filed on Oct. 10, 2016.

(51) Int. Cl. F01C 1/36; B65G 65/46; G01F 13/00; A23P 30/20

(52) U.S. Cl. CPC F01C 1/36; A23P 30/20; G01F 13/00; B65G 65/46

(57) ABSTRACT

A vane powered rotor system or a vane powered rotor may utilize a servomotor and may gently extract, meter, and extrude a product under low pressure. The system or rotor may maintain original product properties of the product during portioning or separation of the product. The system or rotor may include a first group of cavities that may become filled with the product, as the vane powered rotor continuously rotates. The product may be discharged through a second group of cavities opposite the first group of cavities. The first and second group of cavities may be arranged laterally about opposing sides of the vane powered rotor.

### CROSS REFERENCE TO RELATED APPLICATION

This application claims the benefit under 35 U.S.C. § 119(e) of U.S. Provisional Patent Application Ser. No. 62/406,281 filed on Oct. 10, 2016, entitled “Vane Powered Rotor System,” which is incorporated by reference in its entirety.

### TECHNICAL FIELD

The disclosure relates generally to a vane powered rotor system. In particular, the disclosure relates to a vane powered rotor that may gently extract, meter and extrude a product under low pressure and may not overwork the product.

### BACKGROUND

Standard food processing extrusion equipment can provide a system that can divide a product under high pressure. A pressure that is high can overwork the product and result in damage of the chemical structure of the product by standard food processing equipment. Damage to the chemical structure may result in the product being unfit and/or unpleasant for consumption.

### SUMMARY

Embodiments of the present disclosure may provide a vane powered rotor system that may include at least one vane powered rotor that may be enclosed in a cylindrical housing. The at least one vane powered rotor may be arranged to gently meter, extrude, and portion a product under a low pressure and maintain properties of the product. The low pressure may be approximately between 5 to 15 pounds per square inch (psi). The system may include a hopper that may provided to feed the product into an auger tunnel. The product may be pressurized and a manifold may be provided to receive the product from the auger tunnel and feed the product to the at least one vane powered rotor. The system may include a first group of cavities that may be arranged laterally about a first side of the at least one vane powered rotor. A second group of cavities may be arranged laterally about a second side of the at least one vane powered rotor. The product may be received by the first group of cavities, discharged by the second group of cavities, and the first group of cavities may vary in volume. The system may include a pair of sliding blades that may be radially connected to the at least one vane powered rotor. An arrangement of the pair of sliding blades may create a vacuum state on a trailing side of the at least one vane powered rotor, and the pair of sliding blades may pull the product into the first group of cavities and the second group of cavities. The first group of cavities may move as the pair of sliding blades rotate and may become the second group of cavities. The at least one vane powered rotor may be a plurality of vane powered rotors. Each of the plurality of vane powered rotors may include a pair of rotating sliding blades, may portion the product under the low pressure, and may maintain the properties of the product. The system may include a plurality of metering segments that may be provided about the at least one vane powered rotor. Each of the plurality of metering segments may be coupled to another of the plurality of metering segments by a plurality of parallel shafts that may be arranged through each of the plurality of metering segments. The pluralilty of parallel shafts may threadably or non-threadably connect the plurality of metering segments and may form a single drive that may rotate all of the plurality of metering segments as a single unit.

Other embodiment of the present disclosure may provide a vane powered rotor system that may include a plurality of vane powered rotors that may be enclosed in a cylindrical housing. The system may include at least two sliding blades that may be radially arranged about each of the plurality of vane powered rotors. The at least two sliding blades may create a vacuum state that may be provided on a trailing side of each vane powered rotor and may pull a pressurized product from a hopper into a first group of cavities and a second group of cavities. The first group of cavities may be arranged laterally about a first side of each of the plurality of vane powered rotors, and the second group of cavities may be arranged laterally about a second side of each of the plurality of vane powered rotors opposite of the first side. The vacuum state may be generated at a plurality of intake ports that may be provided in a plurality of metering segments. A pressurized product may be received by the first group of cavities, discharged by the second group of cavities, and the first group of cavities may vary in volume. The system may provide that a product may be gently metered, extruded, and portioned under a low pressure and may maintain product properties. The low pressure may be approximately 5 to 15 pounds per square inch. The system may include a plurality of metering segments that may be provided about each of the plurality of vane powered rotors. Each of the plurality of metering segments may be coupled to another of the plurality of metering segments by a plurality of parallel shafts that may be arranged through each of the plurality of metering segments. The pluralilty of parallel shafts may be threadably or non-threadably connected the plurality of metering segments, and the plurality of parallel shafts may form a single drive that may rotate all of the plurality of metering segments as a single unit. Each of the plurality of metering segments may solely meter the product. The plurality of vane powered rotors may be capable of being incorporated and utilized in standard food processing equipment.

Other technical features may be readily apparent to one skilled in the art from the following drawings, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 is a side view of a vane powered rotor system according to an embodiment of the present disclosure;

FIG. 2 is a top view of a vane powered rotor system according to an embodiment of the present disclosure;

FIG. 3 is a perspective view of a vane powered rotor assembly according to an embodiment of the present disclosure; and

FIG. 4 is an end of a vane powered rotor assembly according to an embodiment of the present disclosure.

### DETAILED DESCRIPTION

The present disclosure generally provides a vane powered rotor system that may utilize a vane powered rotor. In particular, the present disclosure relates to a vane powered rotor that may maintain original properties of a product during portioning or separation of the product by extrusion food production equipment.

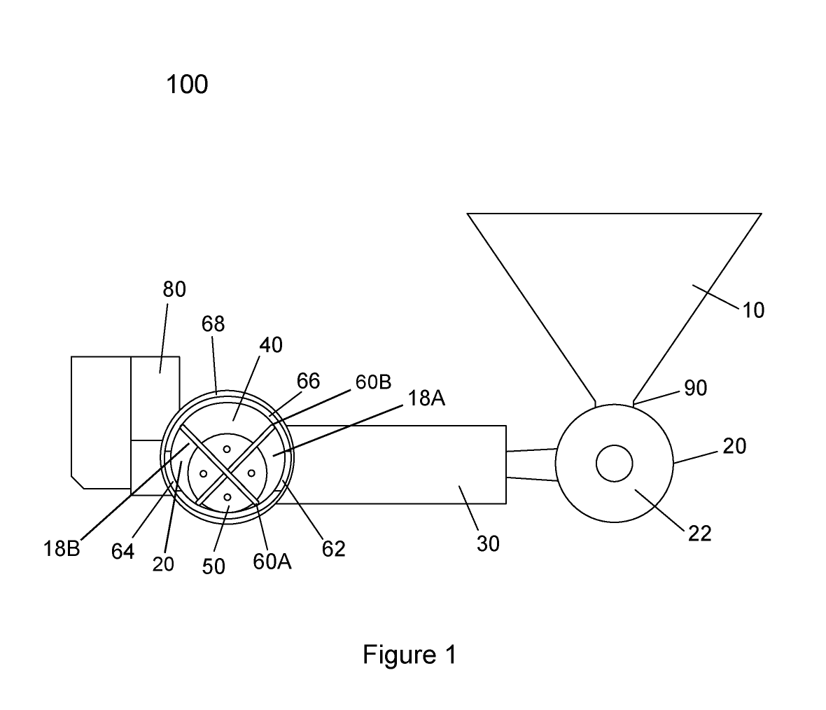

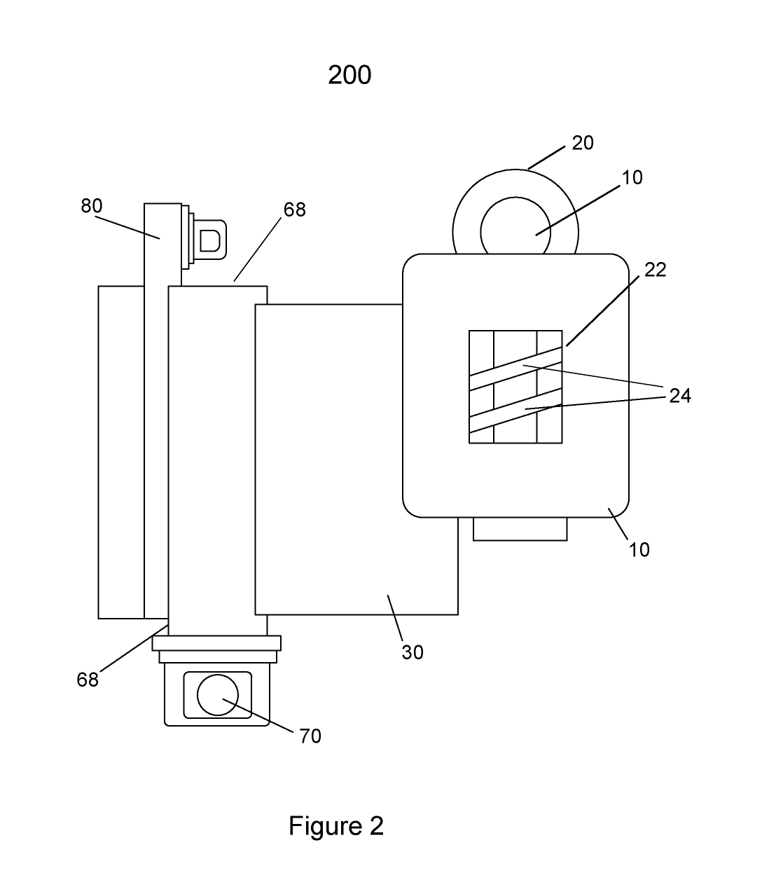

FIGS. 1-2 depict vane powered rotor system (“system”) 100 and top view 200 of system 100, respectively, according to an embodiment of the present disclosure. System 100 may provide hopper 10, auger tunnel 20, manifold 30, off-centric hollow segments 40 (FIG. 1), vane powered rotor (“rotor”) 50 that may be provided with sliding blades or vanes 60A, 60B (FIG. 1), a servo drive (not shown) that may be provided to drive rotor 50, and servo driven cutting knife assembly 80 (FIG. 1). It should be appreciated that system 100 may include a plurality of rotors without departing from the present disclosure. System 100 may be provided to gently portion a product that may be processed by food production equipment. It should be appreciated that system 100 may not overwork or over process the product. It should be appreciated that the product may include, but is not limited to, dough. It should also be appreciated that the end product may include, but is not limited to, baked goods, such as rolls. It should be appreciated that a control panel (not shown) may be incorporated into system 100 without departing from the present disclosure. It should also be appreciated that the control panel may include a display screen that may display a plurality of product recipes and may include a plurality of buttons that may be used in operating system 100. The plurality of buttons may provide a start, stop, and/or an emergency stop option; however, other buttons may be provided without departing from the present disclosure. The control panel may further provide an acknowledgment indicator and a programming logic controller (PLC) indicator that may illuminate. The PLC may control all process sequences and timing required by system 100.

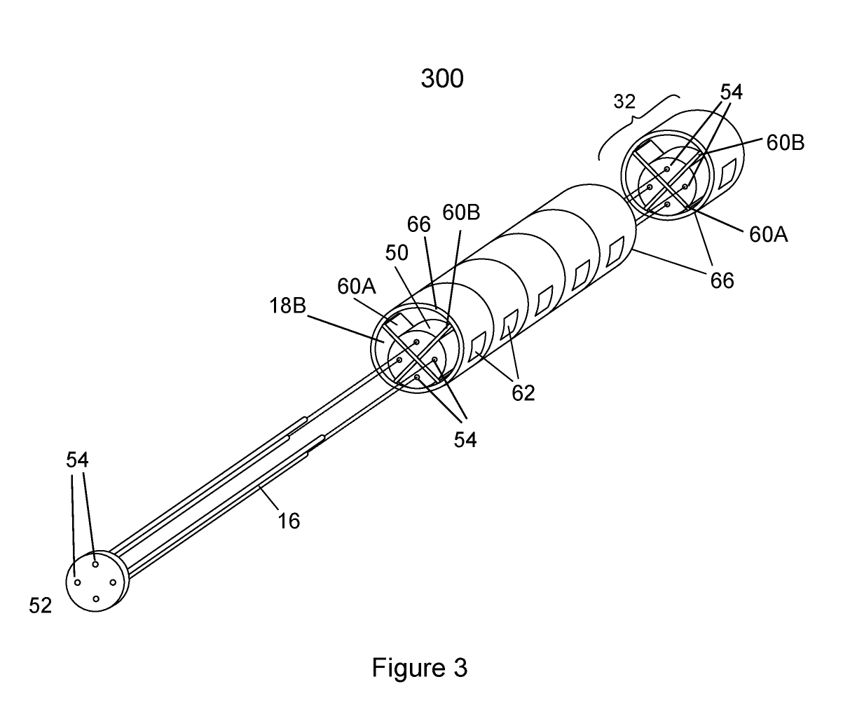

In embodiments of the present disclosure, a product may be dispensed from a mixer or another receptacle (not shown) into hopper 10. As shown in FIGS. 1-2, hopper 10 may provide bottom opening 90 that may lead to auger 22 or a screw conveyor. A vacuum state or a vacuum effect may aid pulling the product onto flights 24 (FIG. 2) of auger 22. Auger 22 may feed the product through bottom opening 90 of hopper 10 and may create a constant product pressure into manifold 30 as auger 22 rotates. It should be appreciated that a single auger or a plurality of augers may be provided in auger tunnel 20, and each auger may rotate without departing from the present disclosure. Auger 22 may provide a leading edge that may provide a sharp edge and a cap or closing member (not shown) that may release and be removed to provide access to auger 22 for cleaning and/or maintenance of auger 22 and flights 24. It should be appreciated that the cap or closing member may prevent mold from forming in system 100, on rotor 50, and/or in the product. The product may be low pressurized dough and may be fed to off-centric hollow segments 40 (FIGS. 1, 3, and 4) of system 100. Off-centric hollow segments 40 may remain in a fixed position relative to rotor 50. Sliding blades 60A, 60B (FIGS. 1, 3, and 4) rotatably connected to rotor 50 may portion or cut the product and create the vacuum state on trailing or upstream side 52 (FIG. 3) of rotor 50.

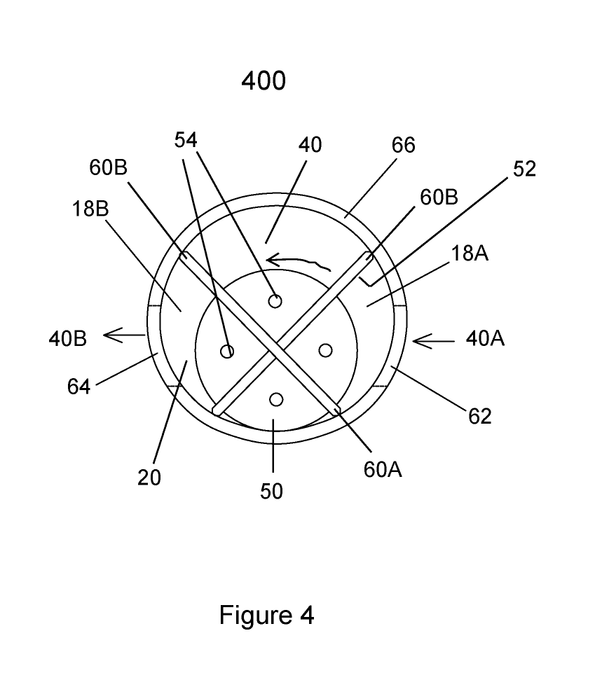

As sliding blades 60A, 60B rotate and slide radially with rotor 50, sliding blades 60A, 60B may create the vacuum state and may pull the product into first group of cavities 18A (FIGS. 1, 3, 4) and second group of cavities 18B (FIGS. 1, 3, 4). This arrangement and motion of sliding blades 60A, 60B may form first group of cavities 18A and second group of cavities 18B that may be volumetric cavities filled by the product to be processed. In particular, first group of cavities 18A may be formed or created by spaces between sliding blades 60A, 60B and may be arranged laterally about first side 40A (FIG. 4) of rotor 50. Second group of cavities 18B may be provided laterally along second side 40B of rotor 50 (FIG. 4). First group of cavities 18A may deliver metered volumetric portions of the product or dough, in a continuous flow, to through each of the plurality of output ports 64 (FIGS. 1, 3, and 4) of metering segments 32 (FIG. 3) prior to the product being cut by knives. Second group of cavities 18B may discharge the product. As rotor 50 and sliding blades 60A, 60B rotate, the position of first group of cavities 18A and second group of cavities 18B change and turn first group of cavities 18A into second group of cavities 18B. It should be appreciated that more or less than two sliding blades may be included in system 100 and/or rotor 50 without departing from the present disclosure.

FIG. 3 depicts rotor assembly 300 that may be removed from system 100 according to an embodiment of the present disclosure. Rotor assembly 300 may gently meter, extrude and portion a product under low pressure that may be processed by food production equipment. It should be appreciated that rotor 50 may be utilized in standard food production equipment. Properties of the product including, but not limited to, plasticity, cohesion and elasticity, may be maintained by system 100 and rotor assembly 300. It should be appreciated that a low pressure may be between approximately 5 to 15 pounds per square inch (psi). It should be appreciated that a low pressure may be less than 5 psi and slightly greater than 15 psi without departing from the present disclosure. The low pressure may be proportional to water absorption of the product. For example, doughs with 40% to 70% water absorption may be used in system 100 with a lower absorption percentage and may exhibit higher processing pressures, and higher absorption percentages may exhibit lower processing pressures. It should be appreciated that the standard operating high pressure of conventional equipment may be between approximately 45 to 60 psi. It should further be appreciated that a high pressure may be less than 45 psi and greater than 60 psi without departing from the present disclosure.

A vacuum state may be generated at intake port 62 of each metering segment 32. It should be appreciated that the vacuum state may be generated on the trailing side of each blade of each metering segment 32 as sliding blades 60A, 60B rotate and glide across intake side port 62. Sliding blades 60A, 60B of rotor 50 may portion or cut the product and create the vacuum state on trailing or upstream side 52 of sliding blades 60A, 60B. Sliding blades 60A, 60B may be provided in system 100 and/or in rotor 50, in which the product to be processed may be under low pressure. Rotor 50 may provide plurality of intake ports 62 and/or tubes that may receive the product from manifold 30 (FIGS. 1 and 2). Sliding blades 60A, 60B may create the vacuum state while rotating in system 100 (FIGS. 1 and 2) or within rotor assembly 300 and may pull the product into first group of cavities 18A and second group of cavities 18B. This arrangement and motion of sliding blades 60A, 60B, while rotor 50 turns on its axes, may form first group of cavities 18A and second group of cavities 18B, which may be variable portioning cavities. First group of cavities 18A may deliver metered volumetric portions of the product or dough, in a continuous flow, to plurality each of the plurality of output ports 64 of metering segments 32 prior to the product being cut by knives or other cutting tools. As rotor 50 and sliding blades 60A, 60B rotate, the position of first group of cavities 18A and second group of cavities 18B change and turn first group of cavities 18A into second group of cavities 18B. Sliding blades 60A, 60B may create volumetric cavities that may be filled by the product to be processed. It should be appreciated that more or less than two sliding blades may be included in system 100 and/or rotor 50 without departing from the present disclosure. It should be appreciated that system 100 and rotor 50 may not overwork or over process the product. It should be appreciated that the product may include, but is not limited to, dough. It should also be appreciated that the end product may include, but is not limited to, baked goods, such as rolls and loaves of bread.

According to an embodiment of the present disclosure, FIG. 4 depicts an end of rotor assembly 400 including rotor 50 that may provide static segments 66 and keyways that may not move. Static segments 66 and keyways may be provided within outer cylinder 68 of system 100. Plurality of metering segments 32 may be driven as a unit. Plurality of metering segments 32 may provide a quantity of 2, 4, 6, 8, and/or 10 ports that may be driven as a unit. It should further be appreciated that plurality of metering segments 32 may be coupled by plurality of driven parallel shafts 16 that may slide through apertures 54 provided in each segment of plurality of metering segments 32, and thus, may create single driven rotor assembly 300 (FIG. 3). The unit may be driven by a single gearbox servomotor (not shown) that may control an even volumetric portion of the product, such as dough for baking, that may be processed.

First group of cavities 18A may be arranged laterally along first side 40A of rotor 50, and second group of cavities 18B may be provided laterally along second side 40B of rotor 50. Interior 20 of rotor may be arranged inside of outer cylinder 68 of rotor and may be driven by the servo motor which may continuously rotate inside of outer cylinder 68. First group of cavities 18A may fill with the product as rotor 50 rotates. The amount of product that may be provided in first group of cavities 18A may be metered. The product may be discharged through second group of cavities 18B opposite first group of cavities 18A. It should be appreciated that first group of cavities 18A may become second group of cavities 18B due to rotation of vanes 6A, 6B. It should also be appreciated that the volume of first group of cavities 18A and second group of cavities 18B may vary as each cavity 18A, 18B moves from intake position to discharge position. Interior 20 may rotate approximately 180 degrees in order to discharge the product from second group of cavities 18B. System 100 may be mounted above the ground. It should be appreciated that system 100 may be mounted approximately 32 inches above the ground without departing from the present disclosure.

Each segment of plurality of metering segments 32 of vane powered rotor cylinder may solely meter the product and may eliminate the need for a standard metering pump. It should be appreciated that the product may be cut with a knife or other cutting tool to target volumetric-weight portions. It should also be appreciated that the knife may be a pendulum-type cutting knife or other oscillatory device or method.

It may be advantageous to set forth definitions of certain words and phrases used in this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An vane powered rotor system, comprising:
at least one vane powered rotor enclosed in a cylindrical housing and arranged to gently meter, extrude, and portion a product under a low pressure and maintain properties of the product.

2. The vane powered rotor system according to claim 1, wherein the low pressure is approximately between 5 to 15 pounds per square inch (psi).

3. The vane powered rotor system according to claim 1 further comprising:
a hopper provided to feed the product into an auger tunnel, wherein the product is pressurized; and
a manifold provided to receive the product from the auger tunnel and feed the product to the at least one vane powered rotor.

4. The vane powered rotor system according to claim 1 further comprising:
a first group of cavities arranged laterally about a first side of the at least one vane powered rotor; and
a second group of cavities arranged laterally about a second side of the at least one vane powered rotor.

5. The vane powered rotor system according to claim 4, wherein the product is received by the first group of cavities and discharged by the second group of cavities, and wherein the first group of cavities varies in volume.

6. The vane powered rotor system according to claim 5 further comprising:
a pair of sliding blades radially connected to the at least one vane powered rotor, wherein an arrangement of the pair of sliding blades creates a vacuum state on a trailing side of the at least one vane powered rotor, and wherein the pair of sliding blades pull the product into the first group of cavities and the second group of cavities.

7. The vane powered rotor system according to claim 6, wherein the first group of cavities move as the pair of sliding blades rotate, and wherein the first group of cavities become the second group of cavities.

8. The vane powered rotor system according to claim 1, wherein the at least one vane powered rotor is a plurality of vane powered rotors, wherein each of the plurality of vane powered rotors includes a pair of rotating sliding blades, and wherein each of the plurality of vane powered rotors portions the product under the low pressure and maintains the properties of the product.

9. The vane powered rotor system according to claim 1 further comprising:
a plurality of metering segments provided about the at least one vane powered rotor, wherein each of the plurality of metering segments is coupled to another of the plurality of metering segments by a plurality of parallel shafts arranged through each of the plurality of metering segments.

10. The vane powered rotor system according to claim 9, wherein the pluralilty of parallel shafts threadably or non-threadably connect the plurality of metering segments, and wherein the plurality of parallel shafts form a single drive that rotate all of the plurality of metering segments as a single unit.

11. A vane powered rotor system, comprising:
a plurality of vane powered rotors enclosed in a cylindrical housing; and
at least two sliding blades radially arranged about each of the plurality of vane powered rotors,
wherein the at least two sliding blades create a vacuum state on a trailing side of each of the plurality of vane powered rotors and pull a pressurized product from a hopper into a first group of cavities and a second group of cavities.

12. The vane powered rotor system according to claim 11,
wherein the first group of cavities is arranged laterally about a first side of each of the plurality of vane powered rotors, and
wherein the second group of cavities is arranged laterally about a second side of each of the plurality of vane powered rotors opposite the first side.

13. The vane powered rotor system according to claim 11, wherein the vacuum state is generated at a plurality of intake ports provided in a plurality of metering segments.

14. The vane powered rotor system according to claim 11, wherein a pressurized product is received by the first group of cavities and discharged by the second group of cavities, and wherein the first group of cavities varies in volume.

15. The vane powered rotor system according to claim 11, wherein a product is gently metered, extruded, and portioned under a low pressure and maintains product properties.

16. The vane powered rotor system according to claim 15, wherein the low pressure is approximately 5 to 15 pounds per square inch.

17. The vane powered rotor system according to claim 11 further comprising:
a plurality of metering segments provided about each of the plurality of vane powered rotors, wherein each of the plurality of metering segments is coupled to another of the plurality of metering segments by a plurality of parallel shafts arranged through each of the plurality of metering segments.

18. The vane powered rotor system according to claim 17, wherein the pluralilty of parallel shafts threadably or non-threadably connect the plurality of metering segments, and wherein the plurality of parallel shafts form a single drive that rotate all of the plurality of metering segments as a single unit.

19. The vane powered rotor system according to claim 17, wherein each of the plurality of metering segments solely meters the product.

20. The vane powered rotor system according to claim 11, wherein the plurality of vane powered rotors are capable of being incorporated and utilized in standard food processing equipment.
